(19) United States
(12) Patent Application Publication
(10) Pub. No.: US 2006/0017673 A1
(43) Pub. Date: Jan. 26, 2006

(54) Flexible display device

(75) Inventors: Brian Chen, Hsindian City (TW); Eric Lin, Hsindian City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 10/938,532

(22) Filed: Sep. 13, 2004

(30) Foreign Application Priority Data
Jul. 21, 2004 (TW) 93211512

(51) Int. Cl. G09G 3/36

(52) U.S. Cl. 345/87

(57) ABSTRACT

The present invention provides a display device, comprising: an input unit, for inputting a data; a storage unit, for storing the input data; an output unit, for displaying the data; a control unit, electrically connected to the input unit, the output unit and the storage unit for controlling the same; a power supply, electrically connected to the input unit, the output unit and the storage unit for providing power to the same; and a housing; wherein the input unit, the output unit, the storage unit, the control unit and the power supply are arranged inside an accommodation space of the housing. In addition, the output unit can be a flexible paper-like display.

### FIELD OF THE INVENTION

The present invention relates to a display device, and more particularly, to a display device using paper-like display as output unit thereof.

### BACKGROUND OF THE INVENTION

With rapid advance of human society, cash as monetary means has gradually been replaced by all kinds of plastic money and commercial notes, e.g. ATM card, credit card, cash card, prepaid card, stock and bond, and so on. Consequently, the number of booklets for recording transactions, such as bank saving book and credit card statement, is also increasing. However, the more booklets we have, the more complicate our life will be, since it is difficult to constantly keep those many booklet up to date and it is troublesome to have to go back to an original monetary institute for replacing an expired booklet. In this regard, a computer-generated display on a paper-like material, which is portable and versatile, is in great demand.

Recently, the personal digital assistant (PDA) gradually becomes popular on the market. Although PDA is expandable and equipped with a plurality of functions, such as notebook, monetary management, dictionary, instant information downloading, it still has the following shortcomings: (a) it is not easy to carry since it uses the rigid display panel; (b) the display interface is not as user friendly as conventional booklets; (c) it lacks ID verification mechanism.

### SUMMARY OF THE INVENTION

The primary object of the invention is to provide a display device employing a flexible paper-like display, which is convenient for carriage.

It is the secondary object of the invention to provide an easy-to-read booklet style display device.

Another object of the invention is to provide a display device having a plurality of thin body type keyboard arranged thereon, which is capable of connecting to a servo for transmitting/receiving data.

Yet, another object of the invention is to provide a display device built-in with a memory or IC for data storage and ID verification.

To achieve the abovementioned objects, the present invention provides a display device, comprising: an input unit, for inputting a data; a storage unit, for storing the input data; an output unit, for displaying the data; a control unit, electrically connected to the input unit, the output unit and the storage unit for controlling the same; a power supply, electrically connected to the input unit, the output unit, the control unit and the storage unit for providing power to the same; and a housing; wherein the input unit, the output unit, the storage unit, the control unit and the power supply are arranged inside an accommodation space of the housing. In addition, the output unit can be a flexible paper-like display.

According to a preferred embodiment of the invention, the display device further comprises a connection unit, which is electrically connected to the input unit, the output unit, the storage unit, the control unit and the power supply and is arranged inside the accommodation space. The connection unit is capable of connecting to a servo for receiving data from the servo or sending data to the servo.

According to another preferred embodiment of the invention, the housing is a booklet, the control unit is a thin body type CPU, the storage unit is a memory and an IC, the output unit, which is a flexible paper-like display, is a liquid crystal display (LCD) of cholesteric liquid crystal, the input unit is a thin body type keyboard, and the power supply is a thin body type battery.

These and other aspects of the invention will be apparent from the preferred embodiment hereinafter described in greater detail, with reference to the accompanying drawings.

### BRIEF DESCRIPTION OF THE DRAWINGS

FIG. 1 is a schematic representation showing a display device of the present invention.

FIG. 2 is an exploded view depicting a preferred embodiment of the present invention.

FIG. 3 is a diagram showing a display device of the present invention.

FIG. 4 is a top view of a display device according to a preferred embodiment of the invention.

### DESCRIPTION OF THE PREFERRED EMBODIMENT

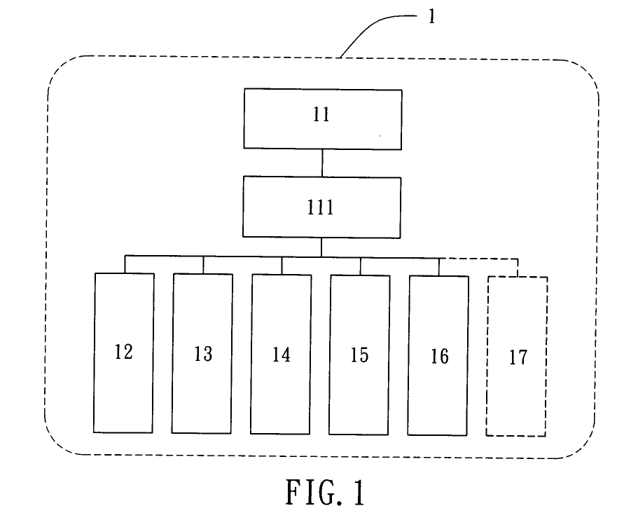

Please refer to FIG. 1, which is a schematic representation showing a display device of the present invention. The display device 1 of the invention comprises: an input unit 12, for inputting a data; a storage unit 13, for storing the input data; an output unit 14, for displaying the data; a control unit 15, capable of controlling every unit arranged in the display device 1; a power supply 16, providing power to the display device 1; and a housing 11; wherein the input unit 12, the output unit 14, the storage unit 13, the control unit 15, and the power supply 16 are arranged inside an accommodation space 111 of the housing 11, and every unit in the display device 1 is electrically connected to one another. In addition, the output unit 14 can be a flexible paper-like display.

As seen in FIG. 1, the display device further comprises a comprises a connection unit 17, which is electrically connected to the input unit 12, the output unit 14, the storage unit 13, the control unit 15 and the power supply 16 and is arranged inside the accommodation space 111. The connection unit 17 is capable of connecting to a servo for receiving data from the servo or sending data to the servo.

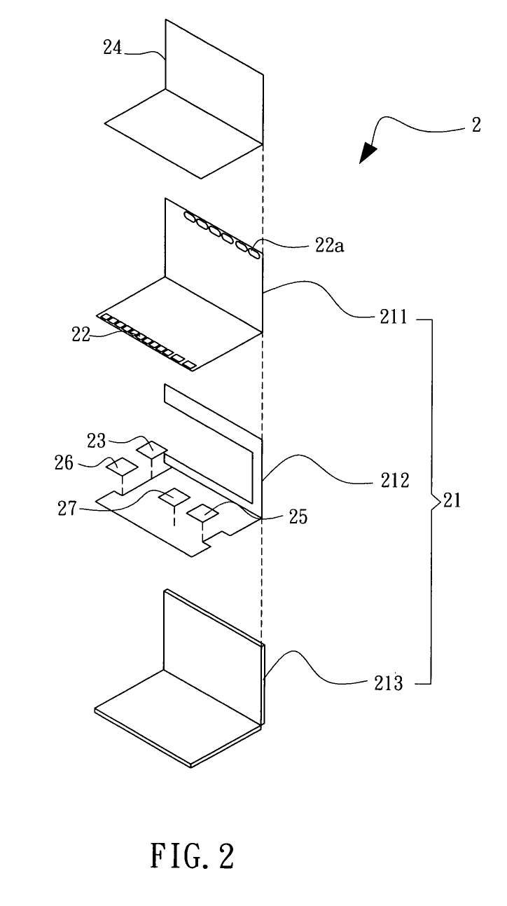

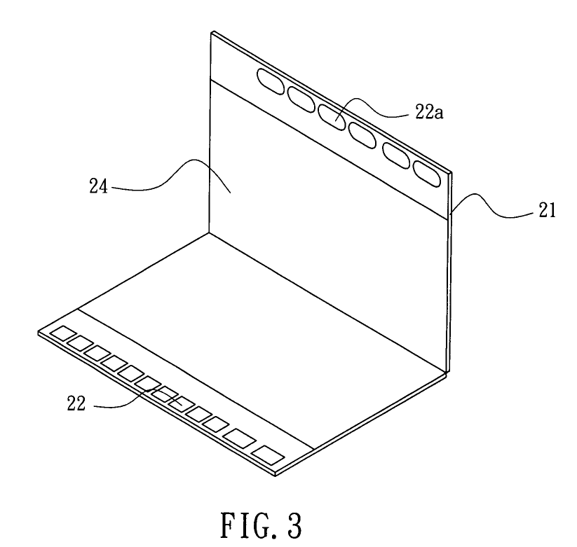

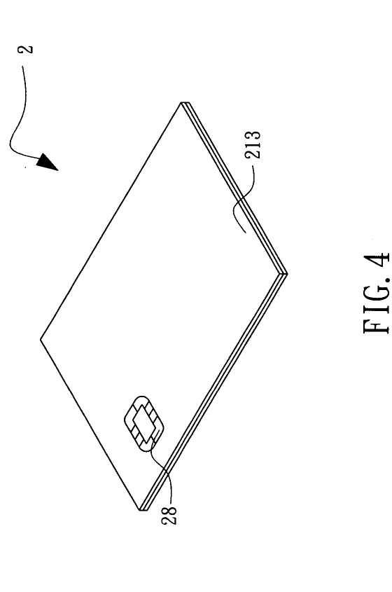

Please refer to FIG. 2, FIG. 3 and FIG. 4, which are diagrams respectively showing an exploded view, an assembly and a top view of a display device according to a preferred embodiment of the invention. In the preferred embodiment, the display device 1 of FIG. 1 is substantially a paper-like display electronic booklet (PLDEB) 2, comprising: a booklet 21; two thin body type keyboard 22, 22a, for inputting a data and switching images; a thin body type memory 23, for storing the data; a flexible LCD 24, for displaying the data; a thin body type CPU 25, for processing the data and controlling every units electrically connected thereto; a thin body type battery 26, for providing power every units electrically connected thereto; and a wireless transmission module 27, capable of connecting to a servo for receiving data from the servo or sending data to the servo. In addition, the booklet 21 further comprises: a inner cover 211, a flexible circuit board 212 and a outer cover 213, wherein both the inner cover 211 and outer cover 213 are foldable and are used for protecting the flexible circuit board and every unit electrically connected thereto.

In assembly, the thin body type memory 23, the thin body type CPU 25, the thin body type battery 26, and the wireless transmission module 27 are arranged on the flexible circuit board 212 for electrically connecting to one another, and the flexible circuit board 212 is connected to both the inner cover 211 and outer cover 213 and is disposed therebetween, and the two thin body type keyboard 22, 22a are connected to the inner cover 211 so as to further connect to the flexible circuit board 212, and the flexible LCD 24 is connected to the inner cover 211 and is arranged thereon, which is further connected to the flexible circuit board 212 by a microcircuit (not shown) for achieving data transmission.

As seen in FIG. 4, the PLDEB 2 further comprises an IC 28, for storing personal information of users and using the same as ID verification, wherein the IC 28 is connected to the outer cover 213 so as to further connect to the flexible circuit 213 by another microcircuit (not shown) for achieving data transmission.

In a preferred embodiment of the invention, the PLDEB 2 is substantially a liquid crystal display of cholesteric liquid crystal, the IC 28 is a chip conforming to a standard selected from the group consisting of the Financial Information Service Corporation, the Europay standard, Master card, and Visa card.

To sum up, the display device of the invention has the following advantages: (1) the present invention uses a flexible paper-like display such that the convenience of carriage is enhanced; (2) the present invention can be realized in a booklet form such that it is to read; (3) the present invention has a built-in memory or IC for data storage and ID verification.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A display device, comprising:
an input unit, for inputting a data;
a storage unit, for storing the data;
an output unit, being substantially a flexible paper-like display, for displaying the data;
a control unit, electrically connected to the input unit, the output unit and the storage unit for controlling the same;
a power supply, electrically connected to the input unit, the output unit, the storage unit and the control unit for providing power to the same; and
a housing;
wherein the input unit, the output unit, the storage unit, the control unit and the power supply are arranged inside an accommodation space of the housing.

2. The display device of claim 1, wherein the display device further comprises: a connection unit, electrically connected to the input unit, the output unit, the storage unit, the control unit and the power supply, being arranged inside the accommodation space, capable of connecting to a servo for communicating data.

3. The display device of claim 2, wherein the connection unit is connected to the servo through a means of wired communication.

4. The display device of claim 2, wherein the connection unit is connected to the servo through a means of wireless communication.

5. The display device of claim 1, wherein the flexible paper-like display is substantially a liquid crystal display of cholesteric liquid crystal.

6. The display device of claim 1, wherein the control unit is a micro center process unit.

7. The display device of claim 1, wherein the input unit is a thin body type keyboard.

8. The display device of claim 1, wherein the storage unit is a thin body type memory.

9. The display device of claim 1, wherein the storage unit is a chip.

10. The display device of claim 9, wherein the chip conforms to the standard of the Financial Information Service Corporation.

11. The display device of claim 9, wherein the chip conforms to a standard selected from the group consisting the Europay standard, Master card, and Visa card.

12. The display device of claim 1, wherein the power supply is a thin body type battery.
